(19) United States
(12) Patent Application Publication
(10) Pub. No.: US 2022/0288995 A1
(43) Pub. Date: Sep. 15, 2022

(54) SNAP-FIT ATTACHMENT REPAIR

(71) Applicant: DENSO International America, Inc., Southfield, MI (US)

(72) Inventors: Justin HARRIS, Southfield, MI (US); Nikolai AKININ, Canton, MI (US)

(21) Appl. No.: 17/196,339

(22) Filed: Mar. 9, 2021

(51) Int. Cl. B60H 1/00

(52) U.S. Cl. CPC B60H 1/00521; B60H 1/00021; B60H 2001/00078

(57) ABSTRACT

A system and method for attaching two automotive cooling modules together is provided. A first cooling module has a tab extending outwardly therefrom, the tab having an aperture extending therethrough. A second cooling module has a backwall and one or more flexible prongs extending in a first direction from the backwall and through the aperture of the tab in a snap-fit attachment. The tab is spaced from the backwall when the one or more prongs are attached to the tab. The second cooling module also has a boss extending in a second direction from the backwall, wherein the boss has a receptacle aligned with the aperture of the tab. In the event of damage to the one or more prongs, the one or more prongs can be removed, and a fastener can be fastened through the aperture of the tab and into the boss.

### TECHNICAL FIELD

The present disclosure relates to repairing a snap fit attachment. In particular embodiments, the present disclosure relates to the repair of a snap fit attachment between heat exchanger components within an automobile.

### BACKGROUND

Automotive powertrain cooling modules typically include a radiator, condenser, oil cooler, fan, and other components. Many of these components can be attached together with a snap fit or slide-in attachments. For example, a radiator can attach to a condenser via a snap-fit or slide-in attachment. These sorts of attachments are cheap (because of no need for a nut or bolt) and relative quick for assembly. However, if a snap-fit attachment or slide-in attachment breaks during assembly or service, the entire component (e.g., the radiator, the condenser, etc.) will be scrapped.

### SUMMARY

In an embodiment, a system for attaching two automotive cooling modules together includes a first cooling module and a second cooling module. The first cooling module has a tab extending outwardly therefrom, the tab having an aperture extending therethrough. The second cooling module has a backwall and one or more flexible prongs extending in a first direction from the backwall and through the aperture of the tab in a snap-fit attachment. The tab is spaced from the backwall when the one or more prongs are attached to the tab. The second cooling module also has a boss extending in a second direction from the backwall, wherein the boss has a receptacle aligned with the aperture of the tab.

In an embodiment, method for servicing an attachment between two automotive components includes: attaching a tab of a first automotive component with prongs of a second automotive component in a snap-fit attachment in which the prongs extend through an aperture of the tab, and wherein the aperture of the tab is aligned with a receptacle formed within a boss of the second automotive component; upon at least one of the prongs being damaged, removing the prongs from the second automotive component; then aligning the aperture of the tab with the receptacle of the second automotive component; and then attaching the tab of the first automotive component with the second automotive component by inserting a fastener through the aperture of the tab and into the receptacle within the boss.

In an embodiment, an attachment includes a first component having a tab extending therefrom, the tab having an aperture extending therethrough; and a second component having a backwall, a pair of prongs extending from the backwall, and a boss extending from the backwall, wherein the boss defines a receptacle extending therein. The first component is attached to the second component in: a first configuration in which the aperture is aligned with the receptacle, the tab is spaced from the backwall, and the prongs extend through the aperture and connect to the tab in a snap-fit attachment; and a second configuration in which the aperture is aligned with the receptacle, the tab is spaced from the backwall, the prongs are removed, and a fastener extends through the aperture and into the receptacle.

### BRIEF DESCRIPTION OF THE DRAWINGS

FIG. 1 is a perspective view of a radiator and a condenser attached to each other utilizing a snap-fit attachment according to an embodiment.

FIG. 2 is an enlarge perspective view of one of the attachments of FIG. 1 between the radiator and the condenser, according to an embodiment.

FIG. 3 is a perspective view of a portion of the attachment of FIG. 2 with a portion of the snap-fit attachment partially broken, according to an embodiment.

FIG. 4A is a front perspective view, and FIG. 4B is a rear perspective view, of a portion of the attachment of FIG. 3 with prongs of the snap-fit attachment completely removed, according to an embodiment.

FIG. 5 is a perspective view of a new attachment being made between the radiator and the condenser, according to an embodiment.

FIG. 6 is a perspective view of the new attachment completed, according to an embodiment.

### DETAILED DESCRIPTION

Embodiments of the present disclosure are described herein. It is to be understood, however, that the disclosed embodiments are merely examples and other embodiments can take various and alternative forms. The figures are not necessarily to scale; some features could be exaggerated or minimized to show details of particular components. Therefore, specific structural and functional details disclosed herein are not to be interpreted as limiting, but merely as a representative basis for teaching one skilled in the art to variously employ the embodiments. As those of ordinary skill in the art will understand, various features illustrated and described with reference to any one of the figures can be combined with features illustrated in one or more other figures to produce embodiments that are not explicitly illustrated or described. The combinations of features illustrated provide representative embodiments for typical applications. Various combinations and modifications of the features consistent with the teachings of this disclosure, however, could be desired for particular applications or implementations.

Automotive powertrain cooling modules typically include a radiator, a condenser, an oil cooler, a fan, and other components. Many of these components can be attached together with a snap fit or slide-in attachments. For example, a radiator can attach to a condenser via a snap-fit or slide-in attachment. These sorts of attachments are cheap (because of no need for a nut or bolt) and relatively quick for assembly. However, if a snap-fit attachment or slide-in attachment breaks during assembly or service, the entire component (e.g., the radiator, the condenser, etc.) might need to be scrapped.

Therefore, according to various embodiments explained herein, an attachment is described herein that inhibits the unnecessary waste of scraping components when parts of a connection break. In embodiments that will be described, a snap-fit connection attachment is provided with prongs from a first component attach to a second component by extending through an aperture of the second component. When attached, the aperture is aligned with a receptacle of a boss in the first component. This way, if a prong is accidentally broken or damaged, both prongs can be removed and an assembler can insert a fastener through the aperture into the receptacle to connect the two components.

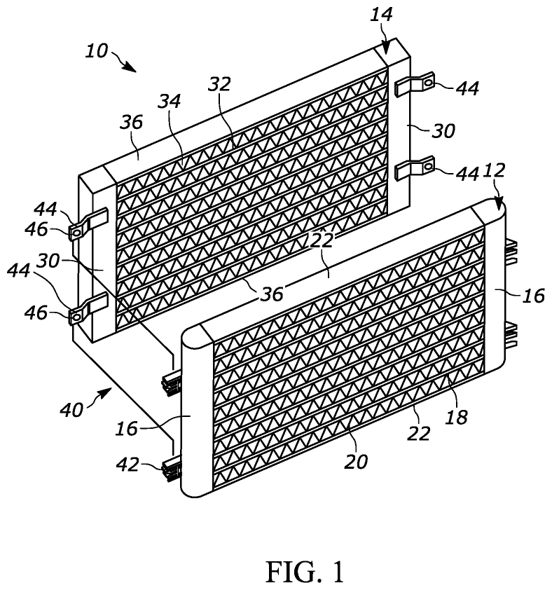

FIG. 1 illustrates an assembly 10 of two components connected together, namely a first heat exchanger (in this case, a radiator 12) and a second heat exchanger (in this case, a condenser 14). The attachment between the radiator 12 and the condenser 14 described herein can apply to any two components desired to be attached together with a snap-fit attachment. The use of a radiator 12 and a condenser 14 is merely exemplary, and should not be viewed as limiting the scope of this disclosure unless otherwise stated. In other embodiments, the attachment described herein can be applied to an attachment between any two automotive cooling modules, for example, an oil cooler or a fan to either a radiator or a condenser.

The radiator 12 includes a pair of tanks 16, a plurality of tubes 18, a plurality of fins 20, and a pair of support brackets 22. The plurality of tubes 18 extend between the pair of tanks 16 and each tube 18 defines one or more fluid passages which are in direct fluid communication with each tank 16. Each of the plurality of fins 20 is disposed between adjacent tubes 18 to increase the heat transfer area of tubes 18. The pair of support brackets 22 are located at opposite sides of the stack of the plurality of tubes 18 and the plurality of fins 20 to provide support for the assembly. The radiator 12 exchanges heat between a first fluid (e.g., air) being blown past the plurality of tubes 18 and the plurality of fins 20 and a second fluid (e.g., engine coolant) flowing through the fluid passages in the plurality of tubes 18 between the pair of tanks 16.

Likewise, the condenser 14 includes a pair of tanks 30, a plurality of tubes 32, a plurality of fins 34 and a pair of support brackets 36. The plurality of tubes 32 extend between the pair of tanks 30 and each tube 32 defines one or more fluid passages which are in direct fluid communication with each tank 30. Each of the plurality of fins 34 is disposed between adjacent tubes 32 to increase the heat transfer area of tubes 32. The pair of support brackets 36 are located at opposite sides of the stack of the plurality of tubes 32 and the plurality of fins 34 to provide support for the assembly. The condenser 14 exchanges heat between a first fluid (e.g., air) being blown past the plurality of tubes 32 and the plurality of fins 34 and a second fluid (e.g., refrigerant) flowing through the fluid passages in the plurality of tubes 32 between the pair of tanks 30.

The radiator 12 and the condenser 14 can be attached via an attachment 40. The attachment 40 can include a snap-fit attachment having prongs 42 extending from the radiator 12 and a tab 44 extending from the condenser 14, in which the prongs 42 extend through an aperture 46 of the tab 44. Of course, the prongs 42 can be extending from any first component, and the tab can be extending from any second component desired to be connected to the first component.

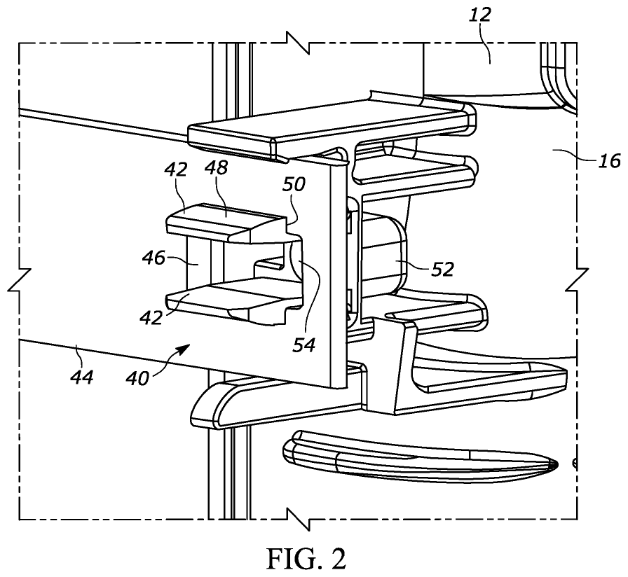

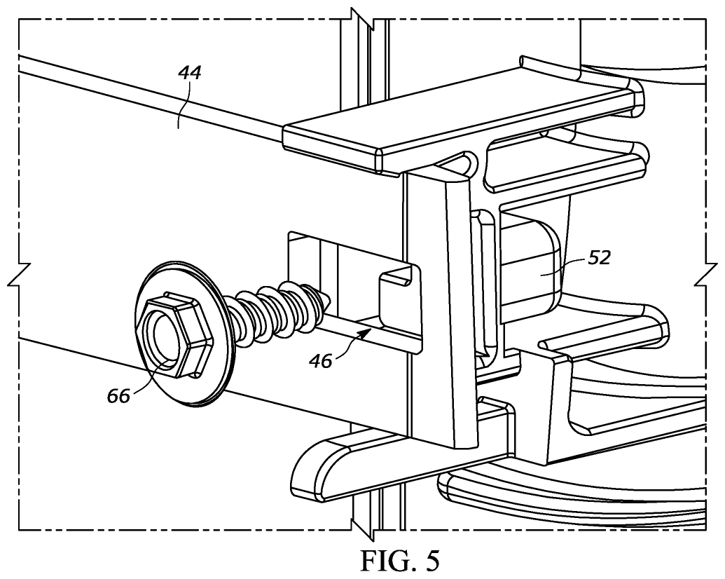

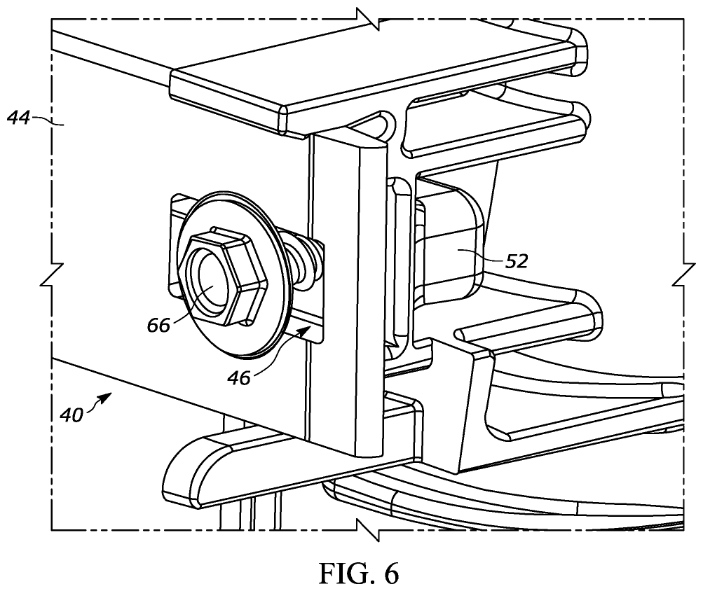

FIGS. 2-4B show the attachment 40 in detail, and FIG. 5-6 show repairing or servicing the attachment 40 in the event of damage to one or more of the prongs 42, as will be described.

Referring to FIG. 2, the attachment 40 is shown with a full snap-fit attachment made between the radiator 12 and the condenser 14. In particular, the prongs 42 are co-molded or otherwise formed to extend from the tank 16. The prongs 42 may be made of plastic or other material that gives the prongs more flexibility than the body of the tank 16. The tab 44 is placed over the prongs 42 such that the aperture 46 of the tab 44 aligns with the prongs 42. The prongs 42 are pressed into the aperture 46. Each prong 42 may have a tapered surface 48 that tapers outwardly and in a direction toward the tank 16. The tapered surfaces 48 facilitate the prongs 42 flexing or bending inward toward one another as the prongs 42 are pressed into the aperture 46. Once the tapered surfaces 48 clear the aperture 46, the prongs 42 are able to flex outwardly toward their normal orientation. Each prong 42 has a ledge 50 at the end of the tapered surface 48. The ledge 50 rests on a planar surface of the tab 44 and inhibits the tab 44 from being removed or separated from the prongs 42. The attachment 40 between the radiator 12 and the condenser 14 thus assumes snap-fit attachment, being a first configuration of the attachment 40.

While two prongs 42 are shown in the illustrations, it should be understood that this is merely exemplary. In other embodiments, only one prong is provided, and a corresponding opening in the tab is sized and configured to receive the single prong.

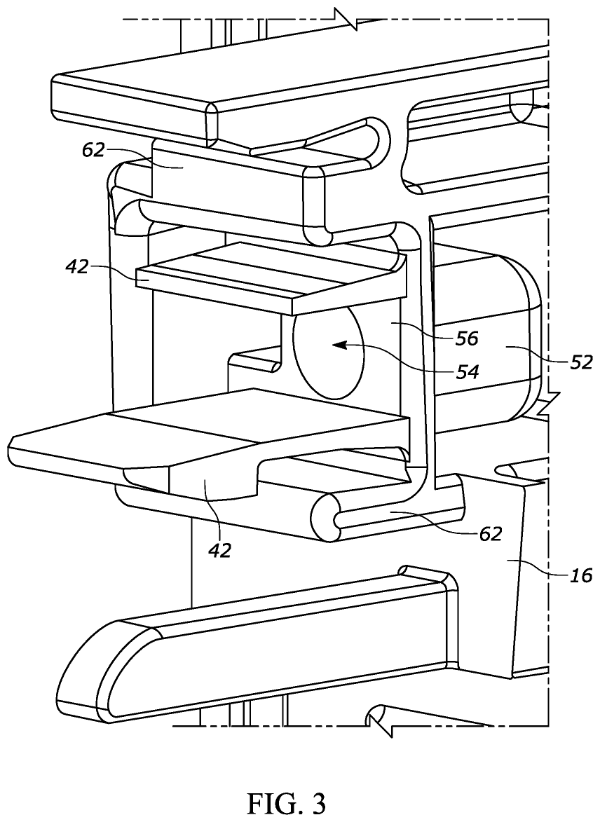

The attachment 40 is also able to assume a second configuration. This configuration can be provided in the event one or both of the prongs 42 is damaged during assembly. For example, if an assembler presses the tab 44 onto the prongs 42 to attempt a snap-fit attachment as shown in FIG. 2, perhaps an imbalance of pressure is applied to the prongs 42 and one of the prongs 42 snaps or breaks. This is shown in FIG. 3, wherein an upper one of the prongs 42 is partially broken. The prong 42 is left with no tapered surface 48 or ledge 50, thus impairing the ability to create a proper snap-fit attachment between the tab 44 and the prongs 42.

The radiator 12 is provided with structure integrally formed therewith to assist an assembler to make a second attachment between the radiator 12 and the condenser 14, namely a second configuration of the attachment 40. In particular, the tank 16 is formed with a boss 52 (also referred to as a projection or protrusion). The boss 52 also has or defines a receptacle 54 therein (also referred to as a pocket, a hole, or the like). The receptacle 54 may only extend partially into the boss 52, or may extend fully through the boss 52. The receptacle 54 is formed at a location between the prongs 42 such that it is aligned with the aperture 46 of the tab 44 when the attachment between the tab 44 and the radiator 12 is being made, or attempted to be made. As will be described further herein, the receptacle 54 is sized and configured to receive a fastener driven through the aperture 46 of the tab 44 to create an attachment 40 according to the second configuration. In other words, the boss 52 and its receptacle 54 are specifically formed at a location to facilitate a fastener attachment when the snap-fit attachment is compromised.

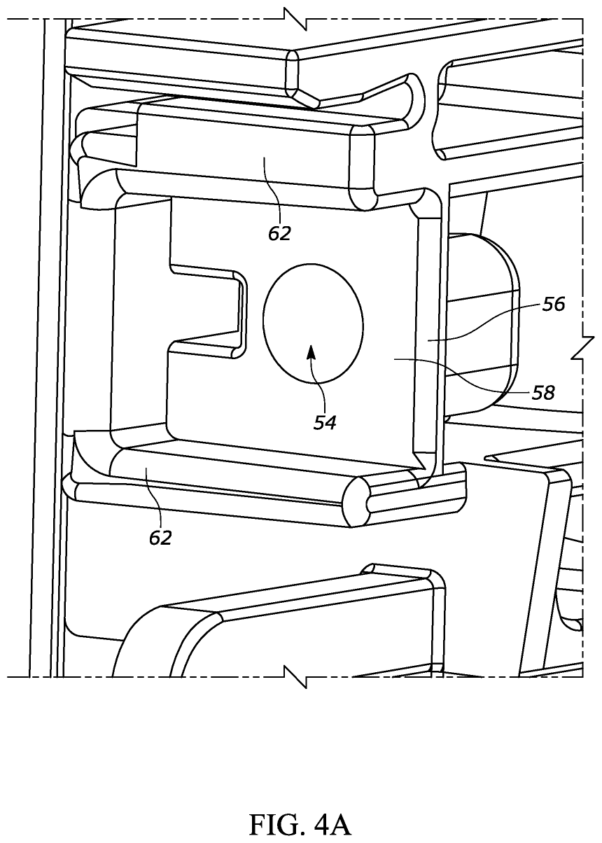

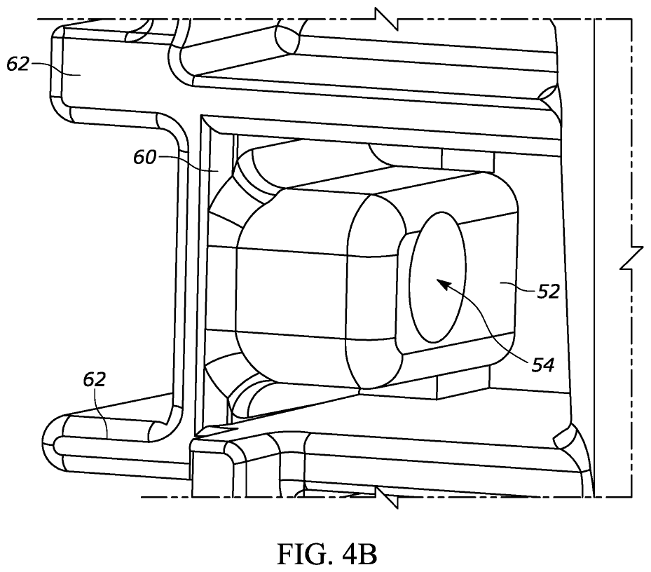

FIGS. 4A-4B show the boss 52 and receptacle 54 in more detail. In this view, the prongs have been removed to prepare for the second configuration of attachment, namely a fastener attachment. An operator may snap off or otherwise remove the prongs when one becomes damaged. The attachment mechanism shown in FIGS. 4A-4B includes a backwall 56. The backwall 56 has a first surface 58 and a second surface 60 facing an opposite direction as the first surface 58. As shown in earlier Figures, the prongs 42 extend from the first surface 58. The boss 52 extends from the second surface 60, e.g. in a direction away from the prongs 42. The receptacle 54 is open at the first surface 58 of the backwall 56, such that a fastener can be driven into the receptacle 54 first through the first surface 58 and in a direction toward the second surface 60. Again, as shown in FIG. 4B, while the receptacle 54 is shown as being open at the backside of the boss 52, in other embodiments the receptacle 54 is closed, and not open on the backside of the boss 52 (i.e., the receptacle 54 extends only partially through the boss 52).

The attachment mechanism shown in FIGS. 4A-4B also includes a pair of sidewalls 62 extending from the first surface 58. The sidewalls 62 provide a landing area configured to contact the tab 44 during attachment. When the tab 44 is later attached (as shown in FIGS. 5-6), the sidewalls 62 support the tab 44 and maintain the tab 44 in a spaced relationship from the first surface 58 of the backwall 56.

The boss 52 provides extra material to allow the receptacle 54 to have relative depth, such that a fastener inserted and driven into the receptacle 54 has ample material to grasp onto during fastening. This eliminates the need for any nut or other fastener to used; a self-tapping fastener (e.g., screw, bolt, or the like) can be driven into the receptacle 54 and tap into the material of the boss 52. The receptacle 54 therefore need not be provided with internal threading; the receptacle 54 can be a smooth cylindrical shape, for example.

FIG. 5 shows a fastener 66 being utilized to form the attachment 40 according to the second configuration, and FIG. 6 shows the attachment 40 being fully performed according to the second configuration. The fastener 66 may be a self-tapping screw or bolt, for example. The fastener 66 can be inserted through the aperture 46 in the tab 44, and into the receptacle 54 of the boss 52, which is aligned with the aperture 46. As can be seen, a gap exists between the tab 44 and the backwall 56 such that the screw extends for some length beyond the tab 44 before contacting the attachment mechanism of the radiator 12.

The fastener 66, when properly inserted through the aperture 46 and secured within the boss 52, connects the first heat exchanger to the second heat exchanger with an attachment 40 according to the second configuration. With this configuration, the tab 44 is reused to form the attachment 40, and the heat exchanger itself does not need to be discarded in case of damage to one or more of the prongs 42.

The steps for creating an attachment between two components and then servicing the attachment will now be described with reference to FIGS. 2-6. First, the tab 44 of a first component is attached to prongs 42 of a second component, wherein the prongs 42 extend through the aperture 46, and wherein the aperture 46 of the tab 44 is aligned with a receptacle 54 formed within a boss 52 of the second component. This is a first configuration of an attachment. In the event at least one of the prongs 42 is damaged, the prongs 42 can be snapped off or otherwise removed from the second component. Then, the aperture 46 of the tab 44 is aligned with the receptacle 54 of the boss 52. Then, the tab 44 is attached to the second component by inserting a fastener 66 through the aperture 46 and into the receptacle 54 of the boss 52. This is a second configuration of the attachment.

While certain structure of the attachment 40 is illustrated as integrally formed with one or more of the attaching components (e.g., the tank), this is not necessary. For example, the tab 44 may be separately attached or otherwise mounted to the component for attaching (e.g., the condenser 14). Also, the boss 52 and its surrounding structure described herein (e.g., the backwall 56, the sidewalls 62, and the like) may be part of a separate attachment mechanism that is separately attached or otherwise mounted to the component for attaching (e.g., the radiator 12). Unless otherwise specified, by saying one component for attaching “has” or “includes” a tab or boss, this should mean that the tab or boss are either integrally formed with the component, or are separately attached or mounted to the component.

While exemplary embodiments are described above, it is not intended that these embodiments describe all possible forms encompassed by the claims. The words used in the specification are words of description rather than limitation, and it is understood that various changes can be made without departing from the spirit and scope of the disclosure. As previously described, the features of various embodiments can be combined to form further embodiments of the invention that may not be explicitly described or illustrated. While various embodiments could have been described as providing advantages or being preferred over other embodiments or prior art implementations with respect to one or more desired characteristics, those of ordinary skill in the art recognize that one or more features or characteristics can be compromised to achieve desired overall system attributes, which depend on the specific application and implementation. These attributes can include, but are not limited to cost, strength, durability, life cycle cost, marketability, appearance, packaging, size, serviceability, weight, manufacturability, ease of assembly, etc. As such, to the extent any embodiments are described as less desirable than other embodiments or prior art implementations with respect to one or more characteristics, these embodiments are not outside the scope of the disclosure and can be desirable for particular applications.

What is claimed is:

1. A system for attaching two automotive cooling modules together, the system comprising:
a first cooling module having a tab extending outwardly therefrom, the tab having an aperture extending therethrough; and
a second cooling module attached to the first cooling module and having:
a backwall;
one or more flexible prongs extending in a first direction from the backwall and through the aperture of the tab in a snap-fit attachment, wherein the tab is spaced from the backwall when the one or more prongs are attached to the tab; and
a boss extending in a second direction from the backwall, wherein the boss has a receptacle aligned with the aperture of the tab.

2. The system of claim 1, wherein the snap-fit attachment provides an attachment between the first cooling module and the second cooling module in a first configuration, and wherein the first cooling module and the second cooling module are configured to be attached in a second configuration in which the one or more prongs are removed and a fastener extends through the aperture of the tab and into the receptacle in the boss.

3. The system of claim 1, wherein the second cooling module includes a pair of sidewalls extending from the backwall in the first direction, and wherein the tab contacts the sidewalls when attached to the second cooling module.

4. The system of claim 3, wherein the boss is spaced from the tab.

5. The system of claim 1, wherein the receptacle is a cylindrical pocket or hole.

6. The system of claim 5, wherein the receptacle does not include a threaded surface.

7. The system of claim 1, wherein the one or more prongs includes a pair of prongs, and the receptacle is located between the pair of prongs.

8. A method for servicing an attachment between two automotive components, the method comprising:
attaching a tab of a first automotive component with prongs of a second automotive component in a snap-fit attachment in which the prongs extend through an aperture of the tab, and wherein the aperture of the tab is aligned with a receptacle formed within a boss of the second automotive component;
upon at least one of the prongs being damaged, removing the prongs from the second automotive component; then
aligning the aperture of the tab with the receptacle of the second automotive component; and then
attaching the tab of the first automotive component with the second automotive component by inserting a fastener through the aperture of the tab and into the receptacle within the boss.

9. The method of claim 8, further comprising:
prior to the step of attaching the tab of the first automotive component with prongs of the second automotive component in a snap-fit attachment, aligning the aperture of the tab with the receptacle of the boss.

10. The method of claim 8, wherein the step of attaching the tab of the first automotive component with the second automotive component by inserting a fastener includes contacting the tab with sidewalls that extend from a wall that the boss extends from such that the tab remains spaced from the boss.

11. The method of claim 8, wherein the inserting a fastener includes inserting a self-tapping screw.

12. The method of claim 8, wherein the removing the prongs from the second automotive component includes snapping the prongs off of the second automotive component.

13. An attachment comprising:
a first component having a tab extending therefrom, the tab having an aperture extending therethrough; and
a second component having a backwall, a pair of prongs extending from the backwall, and a boss extending from the backwall, wherein the boss defines a receptacle extending therein;
wherein the first component is attached to the second component in:
a first configuration in which the aperture is aligned with the receptacle, the tab is spaced from the backwall, and the prongs extend through the aperture and connect to the tab in a snap-fit attachment, and
a second configuration in which the aperture is aligned with the receptacle, the tab is spaced from the backwall, the prongs are removed, and a fastener extends through the aperture and into the receptacle.

14. The attachment of claim 13, wherein the backwall includes a first surface and an opposed second surface, wherein the pair of prongs extend from the first surface and the boss extends from the second surface.

15. The attachment of claim 14, wherein the second component includes a pair of sidewalls extending from the first surface, and wherein the tab contacts the sidewalls when attached to the second component in the first configuration and in the second configuration.

16. The attachment of claim 13, wherein the receptacle extends only partially into the boss.

17. The attachment of claim 13, wherein the fastener is a self-tapping fastener.

18. The attachment of claim 13, wherein the boss is a solid material except for the receptacle such that the fastener is non-accessible from any side of the boss when extending into the boss in the second configuration.

19. The attachment of claim 18, wherein the fastener attaches the first component to the second component in the second configuration without a nut.

20. The attachment of claim 13, wherein a gap exists between the tab and the backwall such that in the second configuration the fastener extends for a length beyond the tab before contacting the backwall.
